(19) United States
(12) Patent Application Publication
(10) Pub. No.: US 2023/0376918 A1
(43) Pub. Date: Nov. 23, 2023

(54) BLOCKCHAIN-BASED DIGITAL PAYMENTS PLATFORM

(71) Applicant: chaya Gangadarappa, fulton, GA (US)

(72) Inventor: chaya Gangadarappa, fulton, GA (US)

(21) Appl. No.: 18/126,478

(22) Filed: Mar. 27, 2023

Related U.S. Application Data
(60) Provisional application No. 63/325,402, filed on Mar. 30, 2022.

(51) Int. Cl. G06Q 20/10; G06Q 20/38; G06Q 20/32; G06Q 20/36

(52) U.S. Cl. CPC G06Q 20/108; G06Q 20/389; G06Q 20/3267; G06Q 20/3678

(57) ABSTRACT

In one aspect, a computer system useful for implementing a blockchain-based digital payments and money transfer application provides blockchain-based digital payments and money transfer application; provide a creates a blockchain-based digital cash account; enables a user to download a blockchain-based digital cash account application from an online mobile store using the blockchain-based digital cash application; enables a user to download the blockchain-based digital cash account on the user's mobile device and open the blockchain-based digital cash account; enable the user to then tap a profile logo; sends a one-time password (OTP) to a registered mobile number of the user; and enables the user to enter the one-time password (OTP) into the blockchain-based digital cash application.

### CLAIM OF PRIORITY

This application claims priority to U.S. Provisional Application No. 63/325,402, filed on Mar. 30, 2022, and titled International Payment tool. This provisional patent application is hereby incorporated by reference in its entirety.

### BACKGROUND

Digital payments have improved how customers can pay for goods and services with vendors. Therefore, there is a desire to improve on technologies that enable digital payments to vendors and other payments without carrying. It is important to keep these digital payments as safe, simple and secure as possible. Accordingly, there is a need to provide a technical method for simple and secure payment between two accounts for substantially instant (e.g. assuming network and processing latencies) transactions in order to promotes a cashless economy. Enabling digital transactions through multiple accounts is also desired.

### SUMMARY OF THE INVENTION

In one aspect, a computer system useful for implementing a blockchain-based digital payments and money transfer application provides blockchain-based digital payments and money transfer application; provide a creates a blockchain-based digital cash account; enables a user to download a blockchain-based digital cash account application from an online mobile store using the blockchain-based digital cash application; enables a user to download the blockchain-based digital cash account on the user's mobile device and open the blockchain-based digital cash account; enable the user to then tap a profile logo; sends a one-time password (OTP) to a registered mobile number of the user; and enables the user to enter the one-time password (OTP) into the blockchain-based digital cash application.

### BRIEF DESCRIPTION OF THE DRAWINGS

FIG. 1 illustrates an example process for implementing blockchain-based digital payments and money transfers, according to some embodiments.

FIG. 2 illustrates managing a blockchain-based digital payments and money transfer application, according to some embodiments.

FIGS. 3-11 illustrating screen shots showing an implementation of various processes provided herein, according to some embodiments.

FIG. 12 illustrates an example digital payments platform, according to some embodiments.

FIG. 13 illustrates an example Digital payments platform, according to some embodiments.

FIG. 14 depicts an exemplary computing system that can be configured to perform any one of the processes provided herein.

FIG. 15 illustrates another example blockchain-based digital cash application process, according to some embodiments.

FIG. 16 illustrates an example process for implementing example blockchain-based digital cash applications, according to some embodiments.

The Figures described above are a representative set and are not exhaustive with respect to embodying the invention.

### DESCRIPTION OF THE INVENTION

Disclosed are a system, method, and article of manufacture of automated health spending accounts. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) is a set of subroutine definitions, communication protocols, and/or tools for building software. An API can be a set of clearly defined methods of communication among various components.

Blockchain is a distributed ledger with growing lists of records (e.g. blocks) that are securely linked together via cryptographic hashes. Each block contains a cryptographic hash of the previous block, a timestamp, and transaction data (e.g. represented as a Merkle tree, where data nodes are represented by leaves). The timestamp proves that the transaction data existed when the block was created. Since each block contains information about the previous block, they effectively form a chain (e.g. compare linked list data structure), with each additional block linking to the ones before it. Blockchain transactions are irreversible in that, once they are recorded, the data in any given block cannot be altered retroactively without altering all subsequent blocks.

Cloud computing can involve deploying groups of remote servers and/or software networks that allow centralized data storage and online access to computer services or resources. These groups of remote serves and/or software networks can be a collection of remote computing services.

Digital wallet can be an electronic device, online service, or software program that allows one party to make electronic transactions with another party bartering digital currency units for goods and services.

Distributed ledger is the consensus of replicated, shared, and synchronized digital data that is geographically spread (e.g. distributed) across many sites, countries, or institutions. In contrast to a centralized database, a distributed ledger does not require a central administrator, and consequently does not have a single (e.g. central) point-of-failure. A distributed ledger uses a peer-to-peer (P2P) computer network and consensus algorithms so that the ledger is reliably replicated across distributed computer nodes (e.g. servers, clients, etc.). The most common form of distributed ledger technology is the blockchain (e.g. associated with a cryptocurrency), which can either be on a public or private network.

Matrix barcode can be a two-dimensional barcode (a 2D code). A matrix code can be a QR code. A matrix code can be a two-dimensional way to represent information. It is noted that other types of codes can be utilized in some embodiments (e.g. linear (1-dimensional) codes, barcode, etc.).

### Example Methods

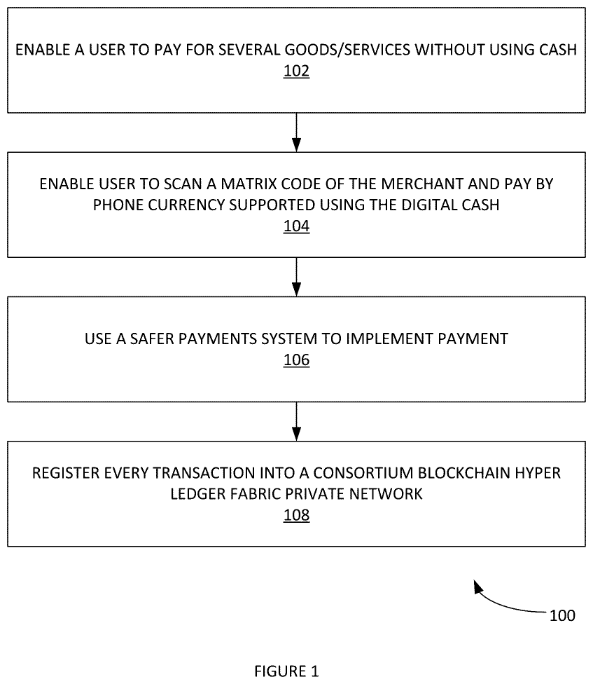

FIG. 1 illustrates an example process 100 for implementing blockchain-based digital payments and money transfers, according to some embodiments. Process 100 can be implemented by blockchain-based digital payments platform (e.g. digital payments platform 1208 discussed infra). In step 102, process 100 can enable a user to pay for several goods/services without using blockchain-based digital cash account (e.g. using a form of digital cash such as Skyscend Cash (SCASH), etc.). The blockchain-based digital cash account can be an easy, safe, and transparent method of payments. The digital cash can be utilized without the user needing to carry a debit or credit card. In step 104, process 100 can enable the user to scan a matrix code (e.g. a QR code, etc.) of the merchant and pay by phone currency supported (e.g. dollars, rupees, etc.) using the digital cash.

In step 106, process 100 uses a safer payments system (e.g. IBM's Safer Payments systems, etc.). Real-time payments fraud prevention. In step 108, process 100 registers every transaction into a consortium blockchain hyper ledger fabric private network. In this way, process 100 provides a blockchain enabled cash application.

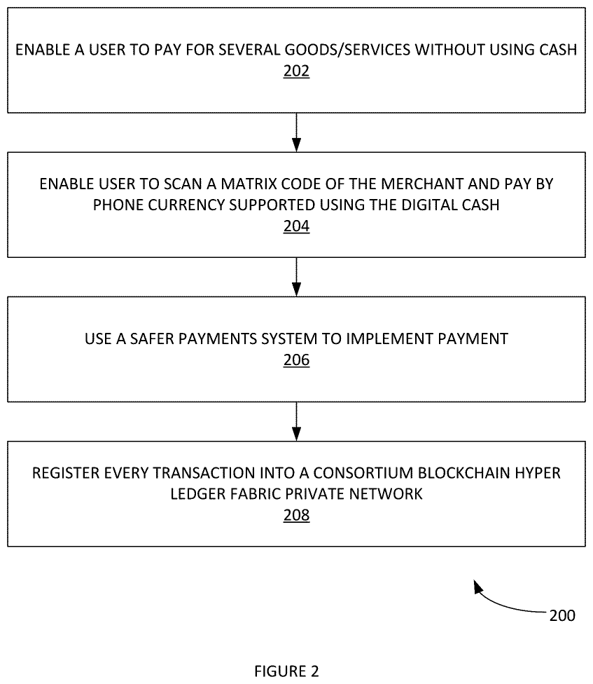

FIG. 2 illustrates managing a blockchain-based digital payments and money transfer application, according to some embodiments. In step 202, process 200 creates a blockchain-based digital cash account. In step 204, process 200 enables a user to download blockchain-based digital cash account application from an online mobile store. The user can also register with the blockchain-based digital cash account system using the blockchain-based digital cash application. In step 206, process 200 enables a user to download the blockchain-based digital cash account on the user's mobile device and open the blockchain-based digital cash account. In step 208, process 200 can enable the user to then tap a profile logo. In step 210, on the new page enter the mobile number and click on Proceed Securely. A one-time password (OTP) can be sent to your registered mobile number, enter the one-time password (OTP), and click on Proceed Securely in step 212. On the next page, a Link Bank Account can be added. Then, the user can complete a minimum KYC and activate your blockchain-based digital cash account wallet (e.g. as a digital wallet, etc.). Then the user can tap on an “agree to the terms and conditions” and click to submit in step 214.

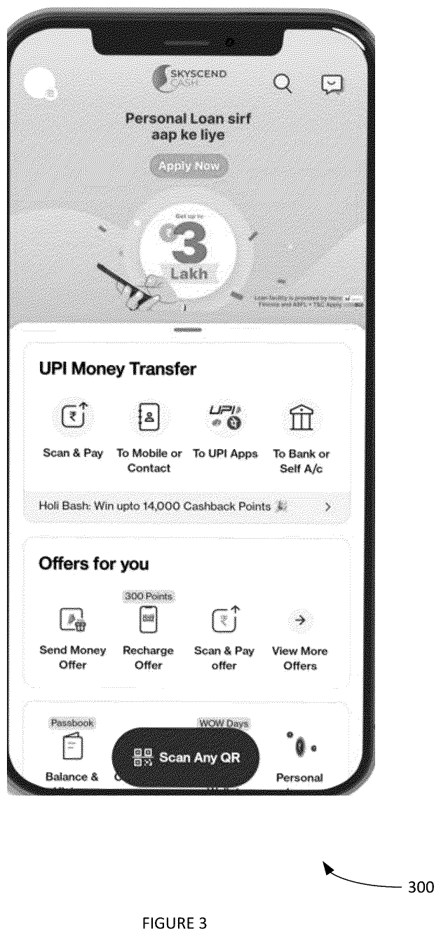

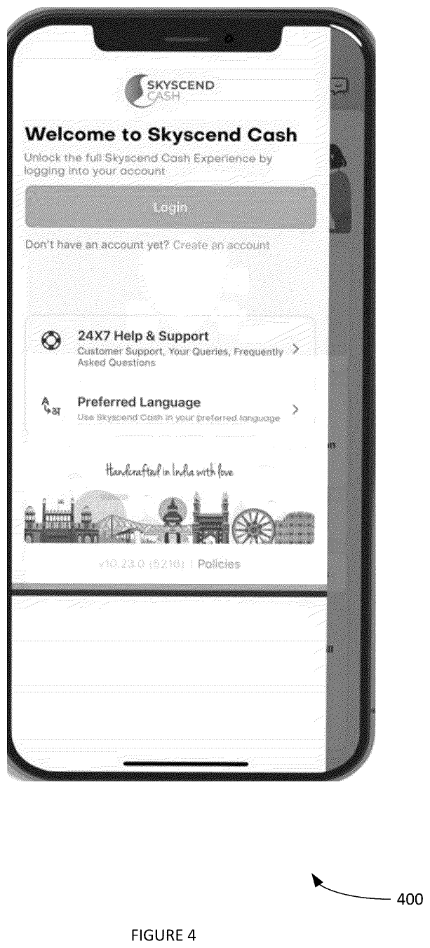

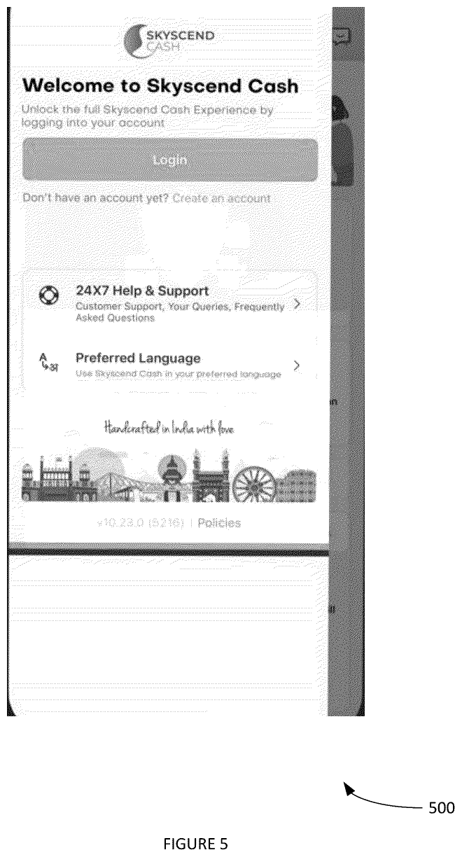

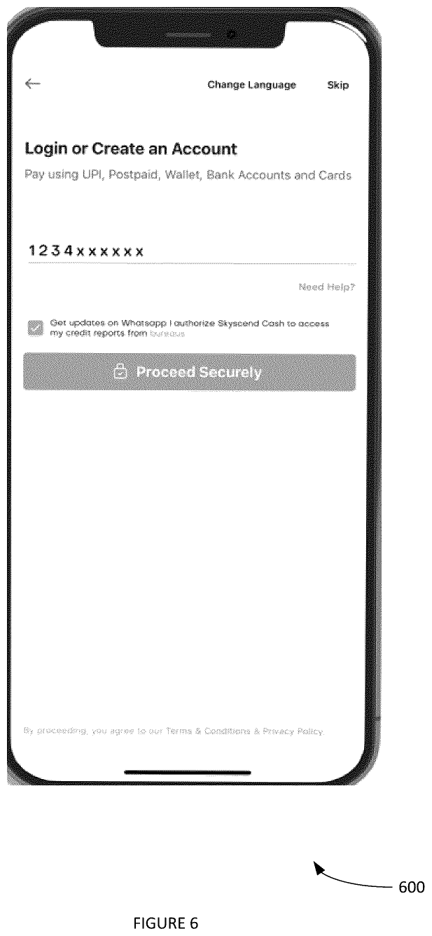

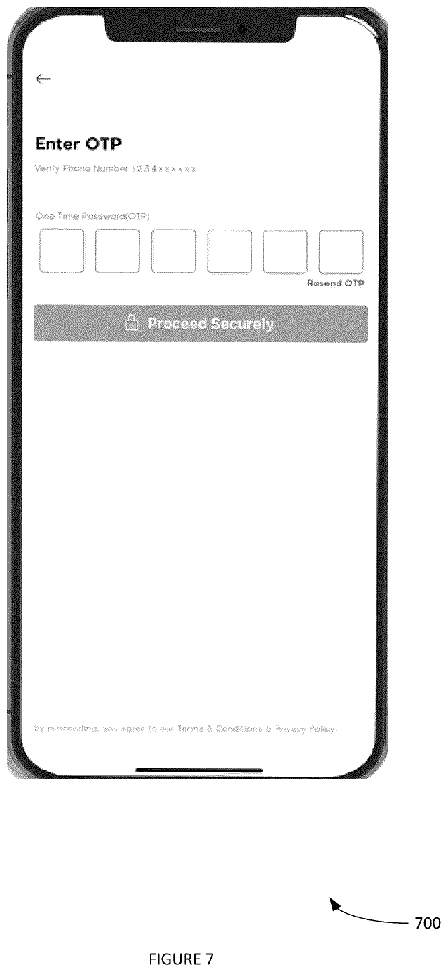

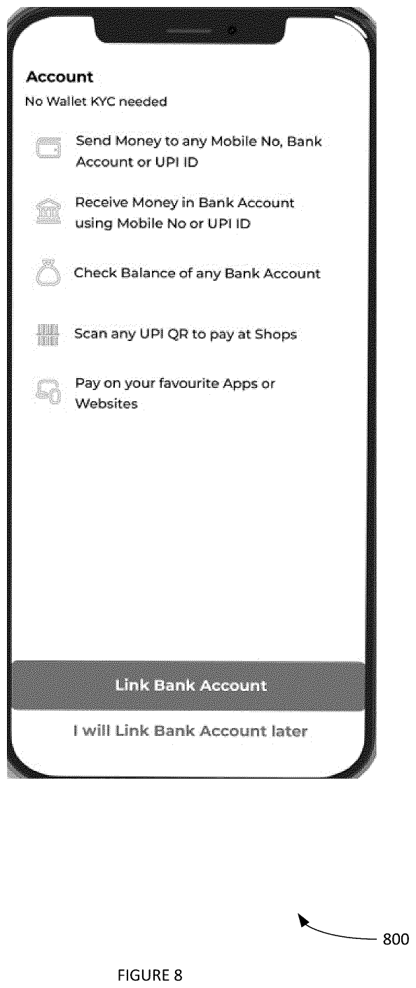

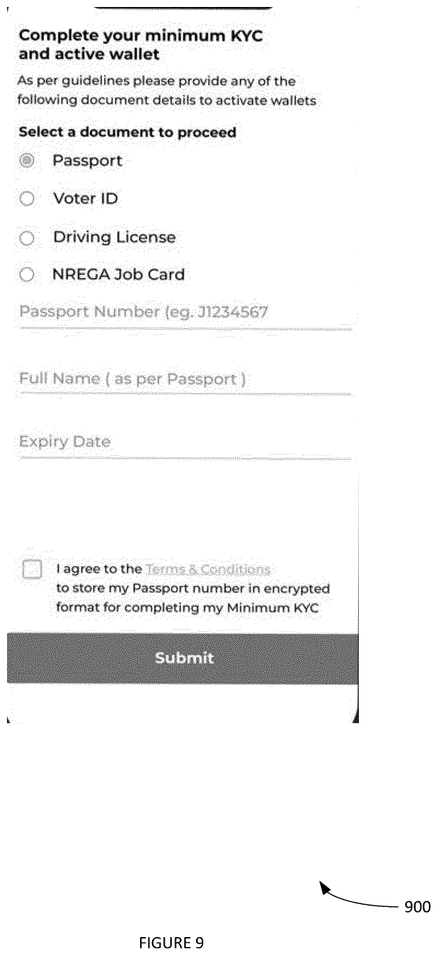

FIGS. 3-11 illustrating screen shots 300-1100 showing an implementation of process 200, according to some embodiments.

### Example Digital Payments Platform

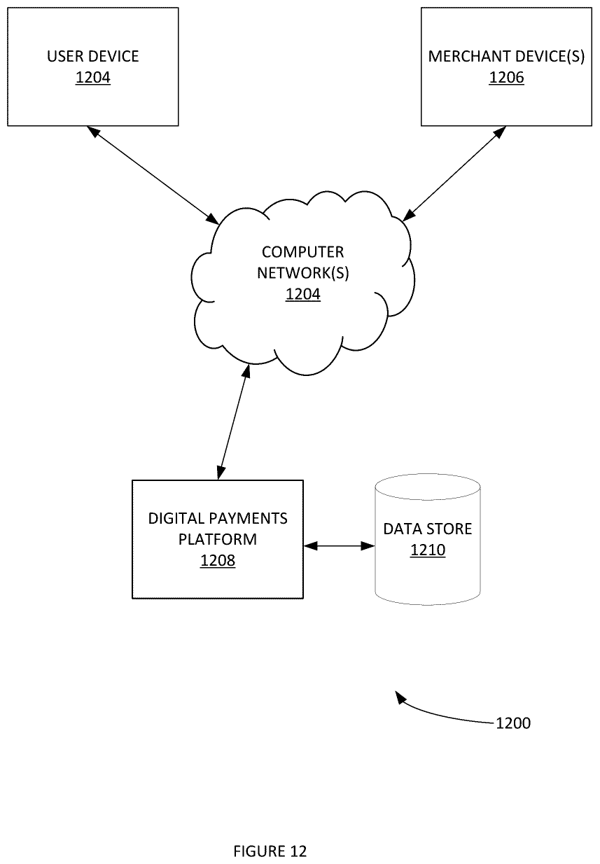

FIG. 12 illustrates an example digital payments platform 1200, according to some embodiments. Digital payments platform 1200 can include computer networks 1202. Computer networks 1202 can include, inter alia: the Internet, cellular networks, WANs, LANs, Wi-Fi networks, etc. User device 1204 can be a mobile device that includes an instance of a blockchain-based digital cash application. Merchant device(s) 1206 can be any computer systems that enables the merchant to perform the merchant-side functions of a blockchain-based digital cash platform (e.g. generate matrix code, electronic payment transactions, etc.).

Digital payments platform 1208 can implement processes provided herein. Digital payments platform 1208 can perform processes 100-200. Digital payments platform 1208 can perform functions related to using a mobile application, like blockchain-based digital cash application, to payments across different countries. Further, digital payments platform 1208 can use a single account (e.g. payment source) for the payments across different countries. Further, digital payments platform 1208 can enable the single mobile application facilitating payments across different countries using different types of payment sources (e.g., checking account, credit card, debit card, savings account, cryptocurrency account, etc.). Digital payments platform 1208 can perform specific sequence of steps to cause the payment being performed (requests, account information, payment information, etc.) being communicated across several payment-related systems (e.g., point of sale devices, mobile device, bank servers, payment exchange servers, credit account exchange servers, crypto currency exchange servers, etc.). Digital payments platform 1208 can secure the information, for example, using encryption, Blockchain, multi-factor authentication, and other techniques. Digital payments platform 1208 can generate identification information (e.g., QR code) for entities involved in the payment process. The identification information may be generated in real time in some aspects. Digital payments platform 1208 can coordinate multiple mobile applications on the mobile device to complete the payment process. Digital payments platform 1208 can implement transactions/requests. These can be routed from the blockchain-based digital cash application to one or more servers (e.g., bank servers, foreign exchange servers, crypto currency servers, credit exchange servers, etc.). Transactions/requests are routed from the blockchain-based digital cash application to one or more mobile applications and processes (e.g., encryption service, hashing service, multi-factor authentication services, etc.). Information is aggregated by the blockchain-based digital cash application in one or more examples. In this way, the user experience is improved. Relevant data can be stored in data store 1210.

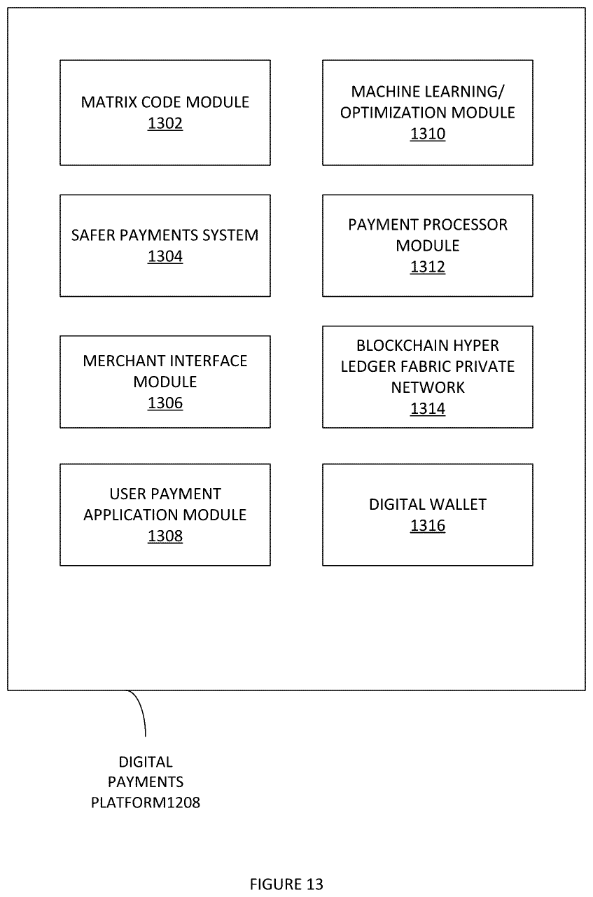

FIG. 13 illustrates an example Digital payments platform 1208, according to some embodiments. Matrix code module 1302 can generate and manage the communication of 2-D matrices in system 1200. Safer payments system 1304 can enable payment security methods and systems. These can be online safe payment systems. Safer payments system 1304 can provide an additional security layer for online credit and debit card transactions. Safer payments system 1304 can leverage third party safer payments services.

Merchant interface module 1306 can generate the merchant side application interfaces as shown in FIGS. 2-11. Merchant interface module 1306 can payment data from merchants and update merchant account information.

User payment application module 1308 can generate the user side application interfaces as shown in FIGS. 2-11. User interface module 1308 can payment data from users and update user account information.

Machine learning/optimization module 1310 can use various ML process to generate models that automate and/or optimize the various steps and systems provided herein. Machine-learning module 1310 can utilize machine learning methods and systems to optimize the various outputs and models used by Digital payments platform 1208. Machine-learning module 1310 can utilize one or more machine learning process(es). Machine learning process(es) can manage and implement the various machine learning operations discussed herein. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Payment processor module 1312 can process the various payments discussed here. Blockchain hyper ledger fabric private network 1314 can registers and obtain every transaction into a consortium blockchain hyper ledger fabric private network. Digital wallet 1316 can manage an electronic device, online service, or software program that allows one party to make electronic transactions with another party bartering digital currency units for goods and services. This can include purchasing items either online or at the point of sale in a brick-and-mortar store, using either mobile payment (on a smartphone or other mobile device) or (for online buying only) using a laptop or other personal computer.

Additional Computing Systems

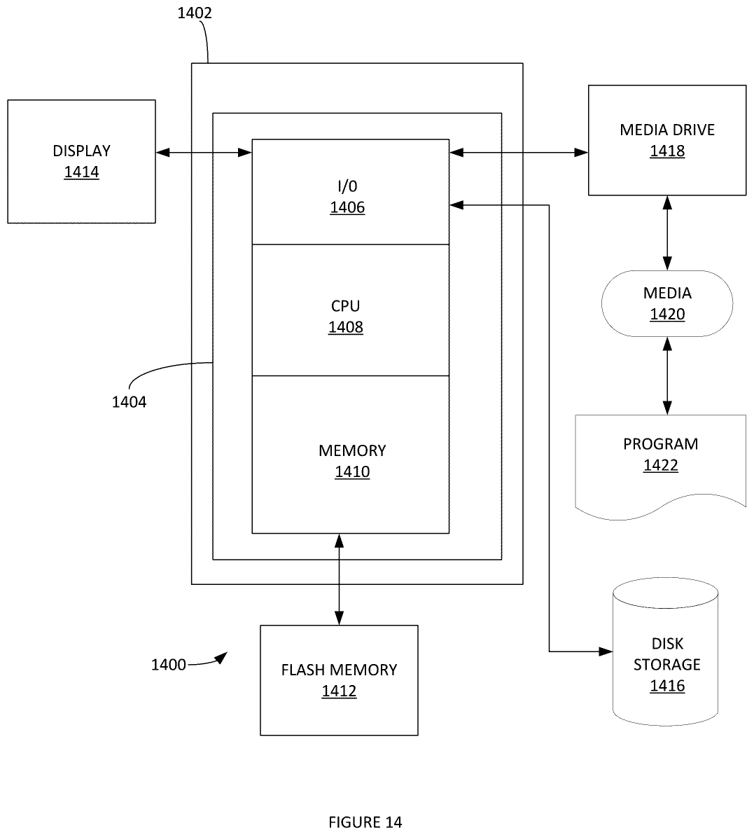

FIG. 14 depicts an exemplary computing system 1400 that can be configured to perform any one of the processes provided herein. In this context, computing system 1400 may include, for example, a processor, memory, storage, and I/O devices (e.g., monitor, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 14 depicts computing system 1400 with a number of components that may be used to perform any of the processes described herein. The main system 1402 includes a motherboard 1404 having an I/O section 1406, one or more central processing units (CPU) 1408, and a memory section 1410, which may have a flash memory card 1412 related to it. The I/O section 1406 can be connected to a display 1414, a keyboard and/or another user input (not shown), a disk storage unit 1416, and a media drive unit 1418. The media drive unit 1418 can read/write a computer-readable medium 1420, which can contain programs 1422 and/or databases. Computing system 1400 can include a web browser. Moreover, it is noted that computing system 1400 can be configured to include additional systems in order to fulfill various functionalities. Computing system 1400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Additional Methods

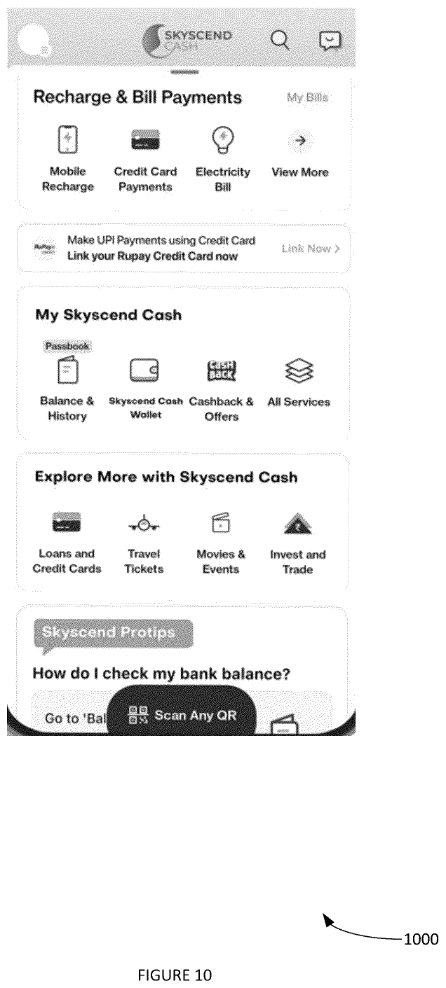

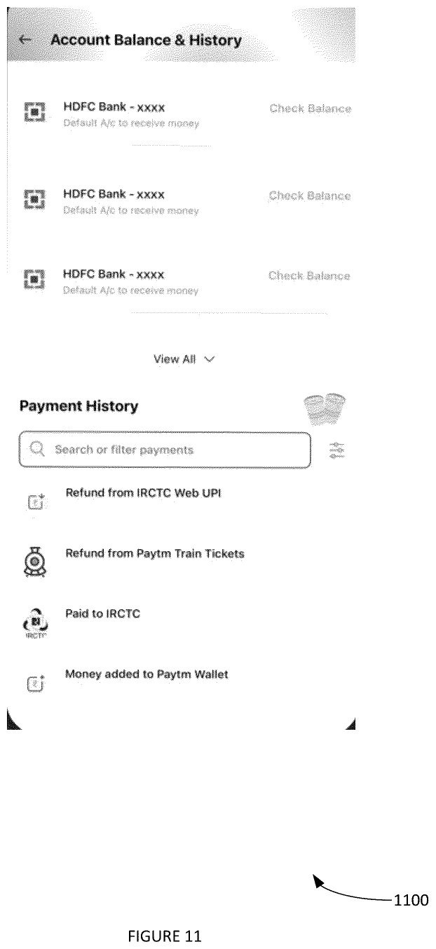

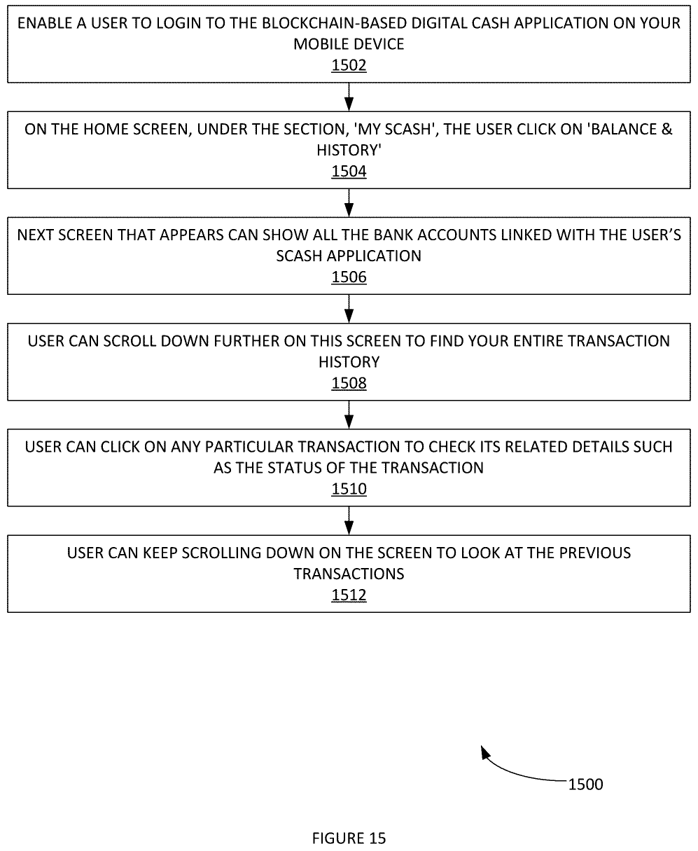

FIG. 15 illustrates another example blockchain-based digital cash application process 1500, according to some embodiments. FIGS. 10 and 11 illustrate example screen shots of process 1500 implementation. In step 1502, process 1500 can enable a user to login to the blockchain-based digital cash application on your mobile device. In step 1504, on the home screen, under the section, ‘My SCash’, the user click on ‘Balance & History’. In step 1506, the next screen that appears can show all the bank accounts linked with the user's SCash application (e.g. the blockchain-based digital cash application). In step 1508, the user can scroll down further on this screen to find your entire transaction history. In step 1510, the user can click on any particular transaction to check its related details such as the status of the transaction (e.g. whether successful or not), transaction time, amount, transaction ID, etc. In step 1512, the user can keep scrolling down on the screen to look at the previous transactions.

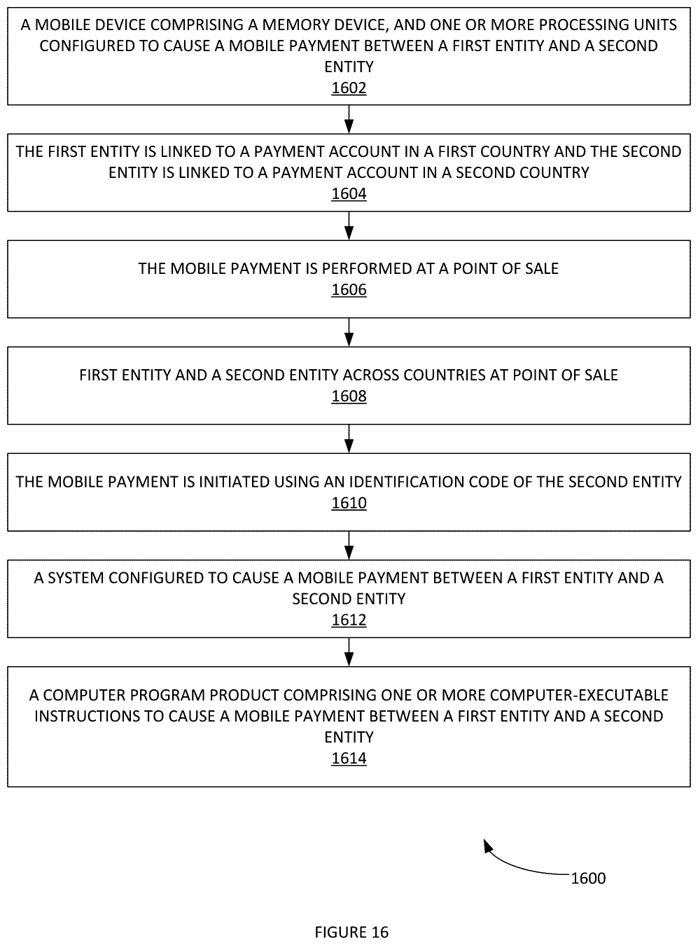

FIG. 16 illustrates an example process 1600 for implementing example blockchain-based digital cash applications in a mobile device, according to some embodiments. A mobile device comprising a memory device, and one or more processing units configured to cause a mobile payment between a first entity and a second entity in step 1602. The first entity is linked to a payment account in a first country and the second entity is linked to a payment account in a second country in step 1604. The mobile payment is performed at a point of sale in step 1606. A first entity and a second entity across countries at point of sale using in step 1608. The mobile payment is initiated using an identification code of the second entity in step 1610. A system configured to cause a mobile payment between a first entity and a second entity in step 1612. A computer program product comprising one or more computer-executable instructions to cause a mobile payment between a first entity and a second entity in step 1614.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computer system useful for implementing a blockchain-based digital payments and money transfer application comprising:
a processor;
a memory containing instructions when executed on the processor, causes the processor to perform operations that:
provide blockchain-based digital payments and money transfer application;
provide a creates a blockchain-based digital cash account;
enable a user to download a blockchain-based digital cash account application from an online mobile store using the blockchain-based digital cash application;
enable a user to download the blockchain-based digital cash account on the user's mobile device and open the blockchain-based digital cash account;
enable the user to then tap a profile logo;
send a one-time password (OTP) to a registered mobile number of the user; and
enable the user to enter the one-time password (OTP) into the blockchain-based digital cash application.

2. The computer system of claim 1, wherein the memory containing instructions when executed on the processor, causes the processor to perform operations that further comprises:
provide a new page of the blockchain-based digital cash account application.

3. The computer system of claim 2, wherein the memory containing instructions when executed on the processor, causes the processor to perform operations that further comprises:
on the new page of the blockchain-based digital cash account application, enable the user to enter the mobile number and click on a Proceed Securely button.

4. The computer system of claim 3, wherein the memory containing instructions when executed on the processor, causes the processor to perform operations that further comprises:
on a next page of the blockchain-based digital cash account application, add a Link Bank Account functionality.

5. The computer system of claim 4, wherein the user completes a minimum KYC.

6. The computer system of claim 5, wherein the user activates a blockchain-based digital cash account wallet.

7. The computer system of claim 6, wherein the blockchain-based digital cash account wallet comprise a digital wallet.

8. The computer system of claim 7, wherein the user taps on an agree to the terms and conditions and clicks to submit.

9. A computerized method useful for implementing a blockchain-based digital payments and money transfer application comprising:
providing blockchain-based digital payments and money transfer application;
providing a creates a blockchain-based digital cash account;
enabling a user to download a blockchain-based digital cash account application from an online mobile store using the blockchain-based digital cash application;
enabling a user to download the blockchain-based digital cash account on the user's mobile device and open the blockchain-based digital cash account;
enabling the user to then tap a profile logo;
sending a one-time password (OTP) to a registered mobile number of the user; and
enabling the user to enter the one-time password (OTP) into the blockchain-based digital cash application.

10. The computerized method of claim 9 further comprising:
providing a new page of the blockchain-based digital cash account application.

11. The computerized method of claim 10, further comprising:
on the new page of the blockchain-based digital cash account application, enabling the user to enter the mobile number and click on a Proceed Securely button.

12. The computerized method of claim 11, further comprising:
on a next page of the blockchain-based digital cash account application, adding a Link Bank Account functionality.

13. The computerized method of claim 12, wherein the user completes a minimum KYC.

14. The computerized method of claim 13, wherein the user activates a blockchain-based digital cash account wallet.

15. The computerized method of claim 14, wherein the blockchain-based digital cash account wallet comprise a digital wallet.

16. The computerized method of claim 15, wherein the user taps on an agree to the terms and conditions and clicks to submit.
